(19) United States
(12) Patent Application Publication
(10) Pub. No.: US 2026/0042563 A1
(43) Pub. Date: Feb. 12, 2026

(54) A LABEL DISPENSER AND A METHOD OF DISPENSING LABELS

(71) Applicant: Dover Europe Sàrl, Vernier (CH)

(72) Inventor: Jonas Södergård, Vastra Frolunda (SE)

(21) Appl. No.: 19/100,474

(22) PCT Filed: Aug. 1, 2023
(86) PCT No.: PCT/EP2023/071309

§ 371 Date: Jan. 31, 2025

(30) Foreign Application Priority Data
Aug. 1, 2022 (SE) 2250937-6
Aug. 1, 2022 (SE) 2250938-4
Aug. 1, 2022 (SE) 2250939-2
Aug. 1, 2022 (SE) 2250940-0
Aug. 1, 2022 (SE) 2250941-8
Aug. 1, 2022 (SE) 2250942-6
Aug. 1, 2022 (SE) 2250943-4
Aug. 1, 2022 (SE) 2250944-2

(51) Int. Cl. B65C 9/42; B41J 3/407; B41J 15/04; B65C 9/00; B65C 9/18

(52) U.S. Cl. CPC B65C 9/42; B41J 3/4075; B41J 15/04; B65C 9/18; B65C 2009/0084

(57) ABSTRACT

The specification relates to a method executed by a controller of a label dispenser for dispensing labels from a label source (120, 230) to an edge portion of the label dispenser. The method comprising: moving the labels between the label source and the label dispenser edge portion and delivering the labels by moving the labels past the label dispenser edge portion of the label dispenser (position E) for application on one or more target objects. The method comprises: controlling the movement of the labels in the label dispenser in at least two different speeds, wherein a first speed (V_{high}) is higher than a second speed (V_{low}), and for each label, using a target time (T_{td}) which is between receiving a trigger signal and delivering said label to the label dispenser (position E), and if the movement of the label is in a speed different than the first speed (V_{high}) accelerating the speed of the label to reach the delivery of the label (position E) in said first speed (V_{high}) substantially at the target time (T_{td}).

### TECHNICAL FIELD

The disclosure relates generally to a method of dispensing labels and in particular aspects, the disclosure relates to a method in a label dispenser for feeding media especially label. The device of disclosure can be applied in label dispensers and in industrial printer applications in general and label printers, in particular.

### BACKGROUND

A labelling machine is used to apply labels to packaging or products. Some known labelling machines comprise a label dispenser that supplies pre-printed labels from a source and an applicator that applies the pre-printed labels to an article. Other known labelling machines may print information onto labels immediately before printed labels are applied to an article. Such labelling machines may be referred to as print and apply (P&A) labelling machines. In some other known labelling machines, an over-printing function may be used that over-prints parts of a label before application of the label.

There is a growing demand for sustainable products and solutions, particularly in every stage of product manufacturing. Label printers and especially industrial label printers are utilized at various points in a production line and are included in sustainability requirements. Industrial label printers are specifically designed for heavy-duty, continuous use in larger-scale labelling operations commonly found in warehouses, factories, and distribution centres. These printers can produce thousands of labels per day. Additionally, industrial label printers may also include a label application component, collectively referred to as Print and Apply (P&A) machines.

Normally, labelling and P&A machines can receive a trigger signal from an external product detection sensor or an external control system. The machines may start operating either immediately upon receiving the signal or after a certain delay. The timing of label delivery from the machine may depend on various factors, including but not limited to the feed/print speed, label length, and the gap length between labels.

Both labelling and P&A machines typically come to a complete stop between two operation cycles. In the case of P&A machines, they usually perform a backfeed between cycles to position the label's starting point at the print head. This ensures that the entire label area can be printed.

The procedures involving acceleration, deceleration, and back feeding require time, which affects the minimum cycle time and, consequently, the overall system throughput.

### SUMMARY

This disclosed arrangements and methods increase the maximum speed of some (automatic) labelling and P&A systems by introducing a new method for controlling the movement of the label printer or label applicator. Consequently, at least one object of the arrangements as disclosed herein is to increase the speed and performance of labelling and P&A applications where the labels are either can be applied directly onto a target object or applied using an applicator that is capable of applying one label while receiving the next label being fed or printed. This could be for example a belt type applicator.

The present disclosure also presents methods and arrangements that can be used to design a label printer that is both easy to use and reliable in high-speed operation. The methods and arrangements of the present disclosure enable overcoming one or several if mentioned shortcomings of the label printers and P&A systems.

According to a first aspect, a method executed by a controller of a label dispenser is provided for dispensing labels from a label source to an edge portion of the label dispenser. The method comprising: moving the labels between the label source and the label dispenser edge portion and delivering the labels by moving the labels past the label dispenser edge portion of the label dispenser (position E) for application on one or more target objects. The method further comprises: controlling the movement of the labels in the label dispenser in at least two different speeds, wherein a first speed is higher than a second speed, and for each label, using a target time which is between receiving a trigger signal and delivering said label to the label dispenser (position E), and if the movement of the label is in a speed different than the first speed accelerating the speed of the label to reach the delivery of the label (position E) in said first speed substantially at the target time.

In one embodiment, the controller further determines based on the time available to target time whether: backfeed of the label is needed (state 1), in which case said label is (i) decelerated until its movement is stopped, and (ii) a backfeed operation is performed to bring said label in a correct position for a printing operation (position A), or no backfeed is needed (state 2), in which case printing of the label will continue at the first speed.

In another exemplary embodiment, the controller further timing the printing operation in state 2 in the time available to target time and deciding either: to print the label continuously at the first speed until said label is moved completely past the label dispenser edge portion, or to decelerate the label until it moves at the second speed and to accelerate the label until it moves at the first speed for delivery, potentially before accelerating maintaining the label at said second speed for a determined amount of time to match the time available to target time. The method may further comprise moving the labels with constant acceleration and deceleration between the first speed and the second speed. In one embodiment, the method may involve the controller further receiving information whether the subsequent label, or alternatively the labels will need to be printed. In yet another example, the second speed is not equal to 0 m/s when the label is printed. In one example embodiment, the trigger signal is received from an external product detection sensor or an external control system and a successive trigger, signals are associated with successive labels. In one example, the method may comprise obtaining information about a new label start, label length and a gap length between successive labels measured during a calibration process.

According to a second aspect, a label dispenser for dispensing labels to an edge portion of the label dispenser. The label dispenser comprising: a label source, an edge portion, a label path extending between the label source and the edge portion, and a controller configured to control the speed of the labels in the label path. The controller is configured to: move the labels between the label source and the label dispenser edge portion, and delivering the labels by moving the labels past the label dispenser edge portion of the label dispenser (position E) for application on one or more target objects, control the movement of the labels in the label dispenser in at least two different speeds, wherein a first speed is higher than a second speed, and for each label, use a target time, which is between receiving a trigger signal and delivering said label to the label dispenser (position E), and determine if the movement of the label is in a speed different than the first speed accelerating the speed of the label to reach the delivery of the label (position E) in said first speed substantially at the target time.

According to a third aspect, the label dispenser comprises a printer arrangement.

According to a fourth aspect, a computer program product is provided, comprising instructions, which when executed on at least the processor, cause the at least one processor to carry out the method of the disclosure.

According to a fifth aspect, a computer program product is provided comprising a program code for performing, when executed by a processing circuitry, the method of the disclosure.

According to a sixth aspect, a non-transitory computer-readable storage medium is provided comprises instructions, which when executed by a processing circuitry, cause the processing circuitry to perform the method according to the disclosure. The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples. Reference is made to the attached drawings, wherein elements having the same reference number designation may represent like elements throughout.

FIG. 1 depicts an exemplary printer in which teachings of the disclosure can be implemented;

FIG. 2 illustrates another side view of the printer according to FIG. 1;

FIG. 3 is a representation of speed vs. time representing process timing in a P&A application;

FIG. 4 is a representation of speed vs. time representing process timing in a labelling application;

FIGS. 5 and 5a to 5f are illustrations of the printhead and feed portion of a label printer, e.g., according to FIG. 1;

FIG. 6 is an exemplary schematic controller according to one aspect of the disclosure;

FIG. 7 is an exemplary label applicator incorporating teachings of the present disclosure; and

FIG. 8 is an exemplary print and apply system in which teachings of the present disclosure are incorporated, and

FIG. 9 is a block diagram illustrating a method according to present disclosure.

### DETAILED DESCRIPTION

The term “industrial printer”, also known as an “industrial-grade printer”, as used herein, may refer to a type of printer specifically designed for heavy-duty printing tasks in industrial environments. These types of printers are built to handle large volumes of printing, often with high-speed and precision, and are capable of printing on various materials such as paper, cardboard, labels, plastics, and metals. The industrial printers, as referred to herein, may commonly be used in sectors like manufacturing, logistics, packaging, and retail, where there is a need for efficient and reliable printing solutions. They are typically more robust and durable compared to standard office printers, as they are required to withstand harsher conditions and extended operation periods.

The terms “ribbon”, “color ribbon” or “ink ribbon” as used herein may generally refer to a consumable component used to transfer ink onto the printing media, typically paper or labels.

The term “label”, as used herein, may include an information carrier media which can be made of several types of materials, depending on the specific requirements and application. Some common materials used for printer labels may for example include (but not limited to): paper, synthetic materials, cardstock, clear and transparent materials, thermal labels, and specialty materials.

The term “label backing paper”, as used herein, may comprise different materials carrying one or several thereon.

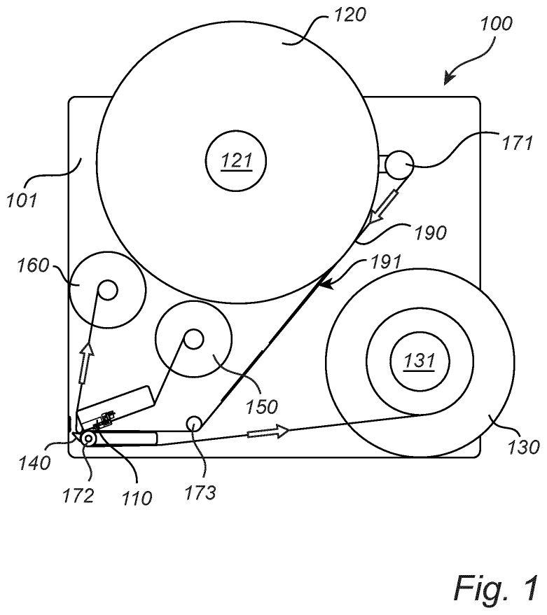

FIG. 1 illustrates, from one side, an exemplary label printer apparatus 100 in which teachings of the present disclosure may be implemented. The printer apparatus 100 comprises a support wall 101 on which are mounted a printhead 110, a label supply spool 120 of label stock mounted to a supply spool support 121, a take up spool 130, an ink ribbon supply spool 150, an ink ribbon take-up spool 160, and a number of rollers 171, 172 and 173. Each label supply spool 120, take-up spool 130 and rollers may directly or indirectly be driven by respective motor or one or several motors with gearing/driving arrangements.

The label web 190 with adhesive labels 191 extends along a web path 120 from the supply spool 120 around the first roller 171, one side of over the second driver roller 172, around a labelling peel beak 140, and is wound onto the take up spool 130.

The ink ribbon may extend from the supply spool 150, passes the printhead's 110 print elements (not shown) and is wound onto the take up spool 160. In this embodiment, the print head 110 comprises a near-edge printhead. During the printing operation, the ink carried on the ribbon is transferred to the label substrate which is to be printed. To affect the transfer of ink, the printhead is brought into contact with the ribbon, and the ribbon is brought into contact with the label substrate and pressed onto the driver roller 172. Each label and ink ribbon supply spool, take up spools and rollers may directly or indirectly be driven by respective motor or one or several motors with gearing/driving arrangements.

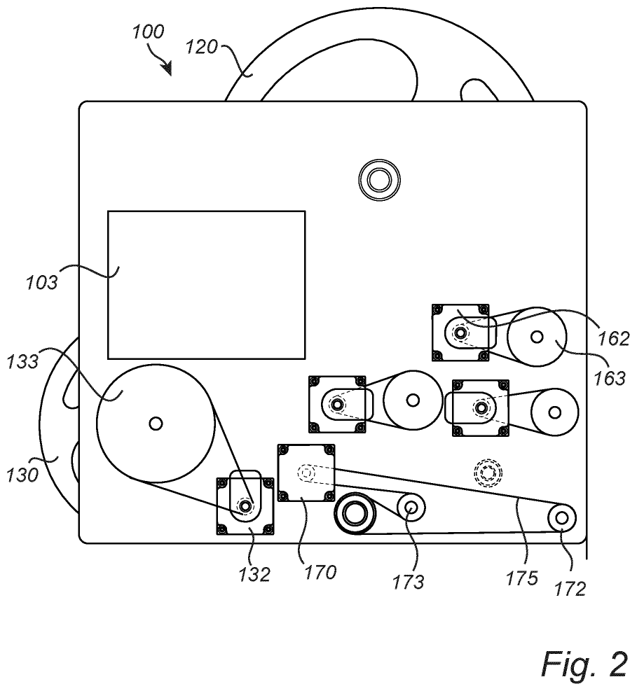

FIG. 2 illustrates the driving mechanisms for printer device 100 of FIG. 1 from the other side of the support wall 101. The backing paper take up spool 130 is driven by a motor 132 and a pulley 133 through a belt, the rollers 172 and 173 are driven by a motor 170 and driving belt 171, the ink ribbon supply 150 is driven by means of a motor 152 and a pulley 153 and the ribbon take up 160 is driven by means of a motor 162 and a pulley 163 through a belt. At least one controller 103 controls the various functions of the printer and also the motors.

According to a first example of a method as disclosed, the controller of a system is provided with information about when the labels are supposed to be delivered to the applicator and let the system decide what needs to be done in order to deliver every label in time. The process used handles the labels one by one without needing to have information about the previous or the next label. The exemplary system comprises a label printer and optionally an applicator.

In one exemplary configuration, the (high-speed) process may use at least two fixed label feed speeds (V_{high} and V_{low}) to achieve maximum performance. If the application is a pure label printing application process, then V_{low} can be set to zero (0). If the application is a P&A application, then a backfeed procedure may be used to prepare the printer for printing a new label from start when there is sufficient time to do so. For example, in batch mode when a batch of trays are delivered by a packaging machine, e.g., 12 trays will approach the printer with a short time (typically 0.2-0.5 seconds) between label application trigger signals. After package 12, then there may be a short period (e.g., some seconds) until the next batch approaches the printer. Then stop and back feed should be carried out. As V_{low} is not zero (0) the non-stop process will not be slow enough to handle the long time (several seconds) between the batches.

The two feed speeds are maintained during the processing of a current label. The values for acceleration and retardation between the stand still and the two feed speeds V_{low} and V_{high} are also not changed during the processing of the current label.

This process can achieve maximum performance by feeding labels without stopping between the labels. The feeding, and printing if used, of every label can be handled separately without a need of information about the previous or following label. The shortest usable label is dictated by the travel distance from stand still up to V_{high} and down to stand still again.

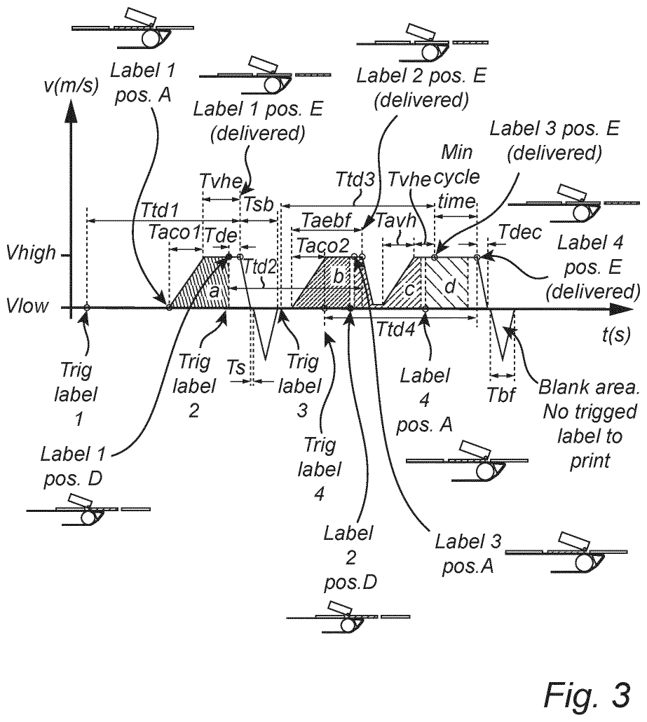

FIG. 3 is a representation of the speed (v) in m/s of the label feed over time (t) in seconds for process timing of a P&A application.

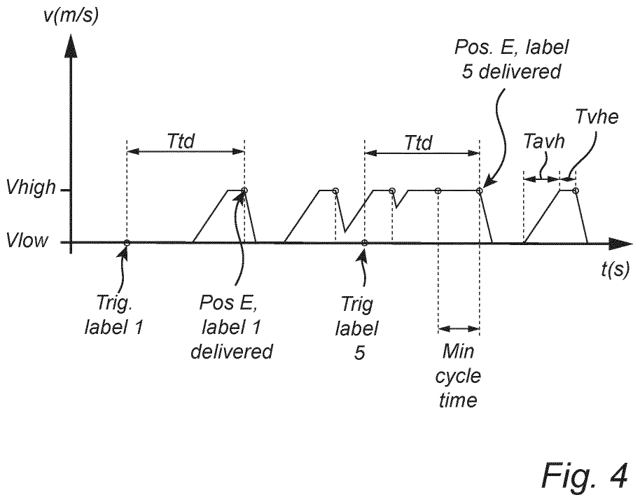

FIG. 4 represents the speed (v) in meter/second of the label feed over time (t) in seconds for a process timing of a labelling application.

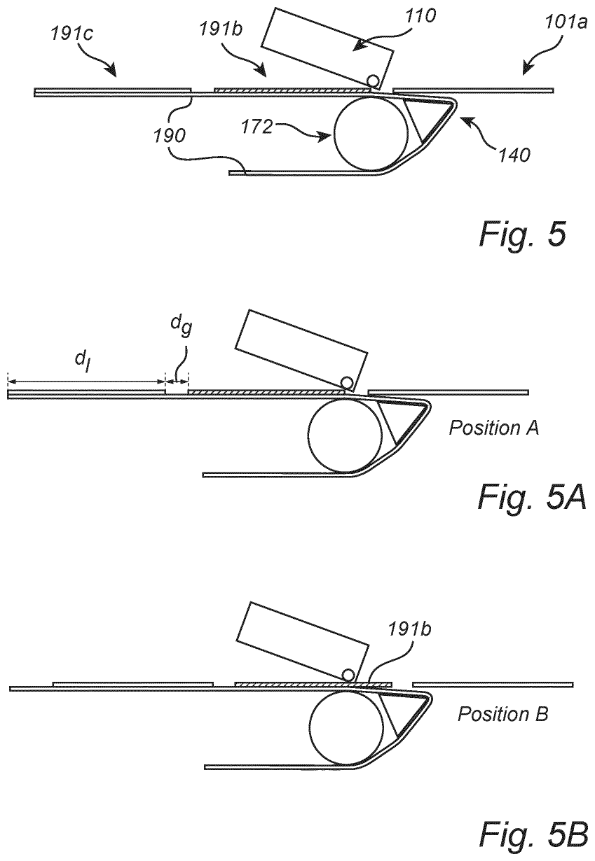

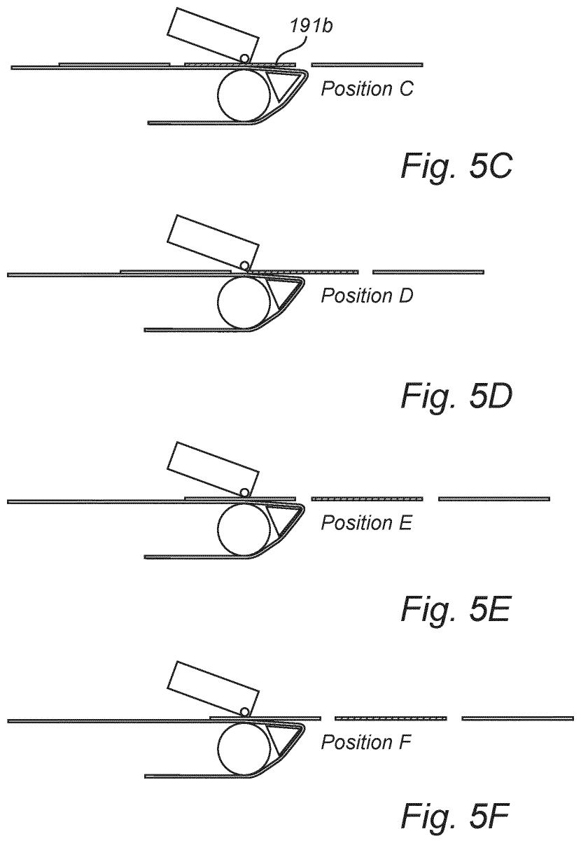

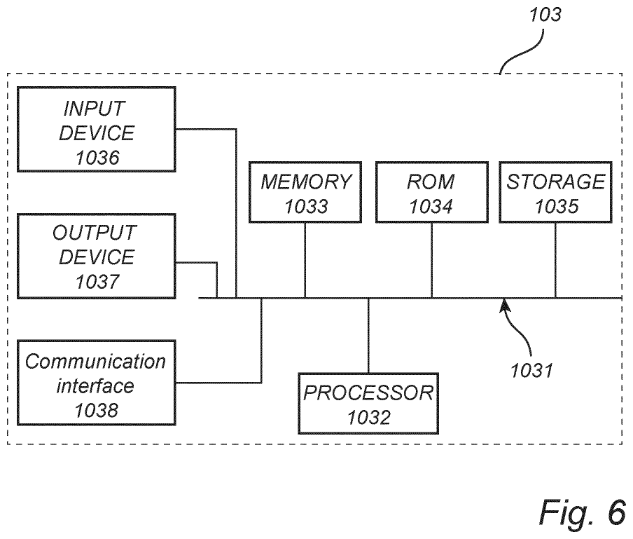

FIG. 5 is a printhead and label feed portion of the exemplary printer of FIG. 1 and FIGS. 5a-5f represent different positions for feeding labels.

In the graphs of FIGS. 3 and 4 following time representations are indicated:
T_{tdn}=Time from trigger signal to delivery of the label n: Delivery=position E.
T_{de}=Time to feed of label from position D to position E.
T_{sb}=Time to start braking (backfeed) at position E down to stand still, wait Tₛ, and backfeeding to position A.
Tₛ=Delay time to create backing paper slack before starting to backfeed.
T_{bf}=Time to backfeed, from stand still to stand still.
T_{aebf}=Time to feed from position A to position E after a backfeed.
T_{accn}=Time to accelerate label n from stand still to V_{high}.
T_{dec}=Time to decelerate from V_{high} to stand still.
Tₐᵥₕ=Time to accelerate from V_{low} to V_{high}.
Tᵥₕₑ=Time to feed the remaining distance at V_{high} to position E.

According to the label dispensing application realised in FIG. 3, a “non-stop” mode is used for every label, i.e., labels to be applied are dispensed without a pause between them. In this case no decision needs to be made about printing at position A. The speed is still V_{high} at position E and V_{low} is substantially zero (0). At position C, slow down to V_{low} is initiated. Since no printing is carried out, no print distortion can be experienced by setting V_{low}=0.

In FIG. 3, hatched section a represents the time and speed for printing a first label, section b represents the time and speed for printing a second label, section c represents the time and speed for printing a third label and section d represents the time and speed for printing a fourth label.

In very schematic FIG. 5, several labels 191a-191c are printed by the printhead 110 and fed to an applicator (not shown in FIG. 5 and FIGS. 5a-5f). For the ease of disclosure, the focus is on the label 191b. The driver roller 172 assists with driving the label web and peel bar 140 assists with detaching the label from the backing paper 190. Label 191b represents the current label being printed.

FIG. 5a, illustrates label 1 (191b) just in position for start printing and the print head 110 is at the front edge of the label 191b, or almost at the end of the gap between labels 191b and 191a. Label 191a is detached (not completely) from the backing paper.

In position B, as illustrated in FIG. 5b, the label 191b has travelled a short distance and is partly printed (if print instructions received). The first label 191a is almost entirely detached from the backing paper, apart from its trailing edge.

In position C, FIG. 5c, the label 191b is almost half printed (if print instructions received), and the label 191a is entirely detached from the backing paper and delivered.

In position D, FIG. 5d, the label 191b is entirely printed and print process is terminated (if print instructions received).

In position E, FIG. 5e, the label 191b is entirely detached from the backing paper and delivered. This position also corresponds to position C for label 191c. Label 191c is printed (if print instructions received).

In position F, FIG. 5f, the label 191b is entirely detached from the backing paper and delivered. Label 191c is further printed (if print instructions received).

Back to FIG. 3, a trigger signal is received for printing label 1. The trigger signal can be received with respect to a sensor signal on the production line detecting the object to be labelled. When the label 1 (191b, FIG. 5a) is in position for printing, the label is accelerated during T_{acc1} and print process (section a) starts shortly after the acceleration is initiated from V_{low} to V_{high}. When the print process is terminated (position D), T_{de} is initiated. Shortly before finishing the print process a trigger signal for label 2 may be received. Before label 2 printing T_{sb} may occur, whereby a backfeed is initiated before label 2 is printed (section b). It is noted that indicated by section c, printing label 3 is started immediately after printing label 2 while label 2 is delivered. Printing label 4 is initiated (section d) immediately after printing label 3. The process is described in the following.

FIG. 5c depicts the position C in which one of two states can be entered:
1. If the label print process is used and it has been decided that backfeed should be used for the current label 191b, then the backfeed process is started at this moment and the first step will be to start reducing speed to stand still before the actual backfeed starts.
2. If no backfeed process is decided, then braking/deceleration down to V_{low} starts at this moment.

If a print process is used or when a new label is triggered, the steps below may be followed to decide how to proceed:

Parameters considered may include:
the remaining time of T_{tdn},
the remaining distance to position E,
the current feed-speed, and
the variables V_{high}, V_{low}, acceleration and deceleration.
i. At specific time or label travel distance, it is checked how long time it will take to accelerate back to speed V_{high} (Tₐᵥₕ) and a distance d it will take. For time calculations or simple real-time periodical calculations or a label travel distance, based on an encoder signal from motors can be used.
ii. Use the information from step i. to check how long time it will take to travel the remaining distance to the delivery at position E (Tᵥₕₑ) at constant V_{high} speed.
iii. If the time left of T_{td}>Tₐᵥₕ+Tᵥₕₑ, i.e., there is still time to continue to decelerate, then continue to decelerate down to V_{low}. Another reason to continue to decelerate down to V_{low} is if no print function is used, meaning there is no state 1 as described above, and there is no new printer trigger. Eventually, there is an active trigger signal and the available time left of T_{td} is not any longer greater than Tₐᵥₕ+Tᵥₕₑ, which implies it is time to act, then start to accelerate to V_{high}. The change can happen as early as before deceleration from V_{high} has even started or as late as that V_{high} has reached one gap length d_{g} (between two labels, FIG. 5a) before position E (e.g., for short labels).

This means that the sum of the length dₗ (FIG. 5a) of one label and d_{g} of one gap must be long enough so that there is enough distance to perform the state 2 above if there is no time to perform above state 1. Consequently, when using a specific label length with a specific gap length, V_{high} and V_{low} can be set to make sure that state 2. above can be made slow enough, with short enough deceleration and acceleration distances, to step in when there is not time to perform a backfeed using state 1. above.

In order to know when the different positions are reached and the travel distance to a certain position, the system may need to know where a new label starts, how long the labels are and the length of the gaps between the labels. This information can be stored in a system controller or measured during a calibration process.

Consequently, the constant delivery speed V_{high} at position E makes it easy to calculate at position A how much time it would take to stop and back feed the label 2 (191b). This in turn makes it easy to decide if back feed of label 2 should be done.

With a variable delivery speed, the stopping distance can be variable. Information about the delivery speed and calculating the corresponding stopping time and distance can then be necessary. The variable stopping distance would also affect the backfeed distance and/or when the stopping should be initiated.

The constant delivery speed at position E makes T_{sb} and T_{aebf} constant, which can be stored in a memory as constants between labels.

In FIG. 4, the difference between timing for a label “1” and for example a label “5” is illustrated to show two different sequences as in label 1 reaches a target speed V_{low}=0 but in the case of the exemplary label 5 the speed does not reach V_{low}=0, i.e. a non-stop feed of the label. Moreover, no backfeed is used as the dispenser does need to consider backfeed for printing operation.

In FIG. 5a, at position A it must be determined if the printing next label should continue or stop printing and wait for the backfeed process.

At position A, it is controlled if a new label is triggered. If it is the case, then it is checked how long is left of the T_{td} timer. To find out if there is time to backfeed, the remaining time to label delivery (T_{td}) is compared to the time it takes to move from position A to position E and include a backfeed on the way. The time necessary for this is a sum of three times, i.e.:

$${T}_{n} = {T}_{f} + {T}_{s b} + {T}_{aebf}$$

Wherein T_{f} is feed to position C, T_{sb} is stop and backfeed, and T_{aebf} is time for feed from position A to position E from stand still.

If Tₙ<T_{td} at position A, then there is time to backfeed.

T_{f} is not constant but needs to be evaluated for every label. It could however be taken from the label feed process. At position A, T_{f} is the same time as the remaining delivery time (T_{td}) for the label feed process. This is because, the position E for the label feed process is same as position C for the label print process.

In some exemplary embodiments, for example when the same product is provided by several labels, a trigger signal may trigger several delivery and print events in parallel. A reason for several parallel timers may be to allow for the trigger sensor to be moved upstream/earlier/further away from the printer/dispenser.

A controller is provided, for example to measure the remaining distance to position E or make necessary calculations and control the label feed mechanism. The controller needs to control the positioning of the moving labels fed through the printer or dispenser relative to a static position. The feeding mechanism may for example pull the backing paper, and the pulling is normally carried out either by the backing paper rewinder or by a roller pressing against the backing paper. Normally the controller needs to know the diameter of the roller doing the pulling as well as the optional gearing between the roller and the motor that drives it in order to estimate how much label transportation every change in the motor angle will cause. An alternative method could be to use a sensor, such as a laser sensor, directed onto the moving backing paper to detect the backing paper movement. In this case there is no need for the controller to know the roller diameter. The controller could then use a control loop with the sensor as input and the motor position as output. For the controller to not only estimate how far the label has been fed but also where one of the edges of the label is relative to the static position then the controller can receive signals from a label gap sensor. The gap sensor can then re-calibrate the label feed process with a known label position. This re-calibration could theoretically also be done with a label trigger sensor sensing the front edge of the label after it has been dispensed.

An exemplary controller 103 communicating with and/or controlling various units of the exemplary printer or label dispenser, e.g., such as a printer described previously in the disclosure, and carrying out previously described assignments is schematically illustrated in FIG. 6. The controller 103 may communicate with various sensors of the printer, such as the encoder for motors 132, 152, 162, and 170. The controller may be stand alone or be part of the printer controller as mentioned previously. The controller 103 as described earlier in which methods and systems described herein may be implemented, may include a bus 1310, a processor 1032, a memory 1033, a read only memory (ROM) 1034, a storage device 1350, an input device 1035, an output device 1037, and a communication interface 1038. The bus 1031 permits communication among the components of controller 103. The bus may be any of several types of bus structures that may further interconnect to a memory bus (with or without a memory controller), a peripheral bus, and/or a local bus using any of a variety of bus architectures. The controller 103 may also include one or more power supplies (not shown). One skilled in the art would recognize that controller 103 may be configured in a number of other ways and may include other or different elements.

The processor 1032 may include any type of processor or microprocessor that interprets and executes instructions. The processor 1032 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor may further include computer executable code that controls operation of the programmable device. The processor 1032 may also include logic that is able to receive and compile instructions and interpret different signal, and also generate output to, for example, a speaker, a display, etc.

The memory 1033 may include a random-access memory (RAM) or another dynamic storage device that stores information and instructions for execution by processor 1032. Memory 1033 may also be used to store temporary variables or other intermediate information during execution of instructions by processor 1032. The memory 1033 may be one or more devices for storing data and/or computer code for completing or facilitating methods described herein. The memory may include database components, object code components, script components, or other types of information structure for supporting the various activities herein. Any distributed or local memory device may be utilized with the systems and methods of this description. The memory may be communicably connected to the processor device (e.g., via a circuit or any other wired, wireless, or network connection) and may include computer code for executing one or more processes described herein. The memory may include non-volatile memory 1034 (e.g., read-only memory (ROM), erasable programmable read-only memory (EPROM), electrically erasable programmable read-only memory (EEPROM), etc.), and volatile memory (e.g., random-access memory (RAM)), or any other medium which can be used to carry or store desired program code in the form of machine-executable instructions or data structures and which can be accessed by a computer or other machine with a processor. A basic input/output system (BIOS) may be stored in the non-volatile memory 1034 and can include the basic routines that help to transfer information between elements within the controller.

ROM 1034 may include a conventional ROM device and/or another static storage device that stores static information and instructions for processor 1032. Storage device 1350 may include a magnetic disk or optical disk and its corresponding drive and/or some other type of magnetic or optical recording medium and its corresponding drive for storing information and instructions. Storage device 1350 may also include a flash memory (e.g., an electrically erasable programmable read only memory (EEPROM)) device for storing information and instructions.

Input device 1035 may include one or more conventional mechanisms that permit a user to input information to the controller 103, such as a keyboard, a keypad, a directional pad, a mouse, a pen, voice recognition, a touch-screen and/or biometric mechanisms, etc. Output device 1037 may include one or more conventional mechanisms that output information to the user, including a display, a printer, one or more speakers, etc. Communication interface 1038 may include any transceiver-like mechanism that enables controller 103 to communicate with other devices and/or systems. For example, communication interface 1038 may include a modem or an Ethernet interface to a LAN. Alternatively, or additionally, communication interface 1038 may include other mechanisms for communicating via a network, such as a wireless network. For example, communication interface may include a radio frequency (RF) transmitter and receiver and one or more antennas for transmitting and receiving RF data.

The controller 103, consistent with the disclosure, provides a platform through which the various functions of applicator stand alone or in combination with a printer are controlled. The controller 103 may also display information associated with the label application status of printer relevant information.

According to an exemplary implementation, controller 103 may perform various processes in response to processor 1032 executing sequences of instructions contained in memory 1033. Such instructions may be read into memory 1033 from another computer-readable medium, such as storage device 1350, or from a separate device via communication interface 1038. It should be understood that a computer-readable medium may include one or more memory devices or carrier waves. Execution of the sequences of instructions contained in memory 1033 causes processor 1032 to perform the acts that have been described. In alternative embodiments, hard-wired circuitry may be used in place of or in combination with software instructions to implement aspects consistent with the disclosure. Thus, the disclosure is not limited to any specific combination of hardware circuitry and software.

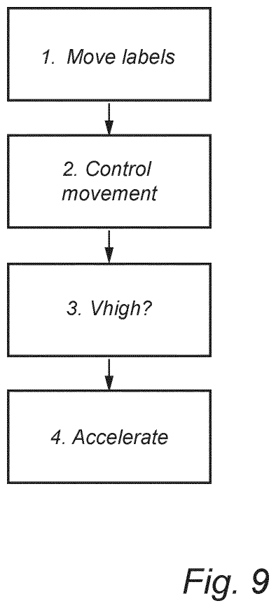

In one exemplary embodiment, as depict in FIG. 9, the controller is arranged to:
1. To move the labels between the label source and the label dispenser edge portion, and delivering the labels by moving the labels past the label dispenser edge portion of the label dispenser (position E) for application on one or more target objects,
2. controlling the movement of the labels in the label dispenser in at least two different speeds, wherein a first speed (V_{high}) is higher than a second speed (V_{low}), and for each label, using a target time (T_{td}) which is between receiving a trigger signal and delivering said label to the label dispenser (position E), and
3. if the movement of the label is in a speed different than the first speed (V_{high})
4. accelerate the speed of the label to reach the delivery of the label (position E) in said first speed (V_{high}) substantially at the target time (T_{td}).

In a printer, such as the printer of FIG. 1, the controller also controls the rollers 172 and 173 by controlling the motor 170 for feeding and backfeed of the backing paper. In some cases, the motor 132 of the take-up spool 130 may also be controlled.

Thus, the methods described herein may be respectively implemented by means of a computer program product, comprising instructions, i.e., software code portions, which, when executed on at least the processor 1032, cause the at least one processor to carry out the actions described herein, as performed by the control unit 103. The computer program product may be stored on a computer-readable storage medium. The computer-readable storage medium, having stored thereon the computer program may comprise instructions which, when executed on at least one processor, cause the at least one processor to carry out the actions described herein, as performed by the control unit 103. The computer-readable storage medium may be a non-transitory computer-readable storage medium, such as a CD ROM disc, or a memory stick. The computer program product may be stored on a carrier containing the computer program just described, wherein the carrier is one of an electronic signal, optical signal, radio signal, or the first computer-readable storage medium, as described above.

A computer program product comprises the program code for performing, when executed by a processing circuitry, the method described herein.

A non-transitory computer-readable storage medium comprises instructions, which when executed by a processing circuitry, cause the processing circuitry to perform the method described herein.

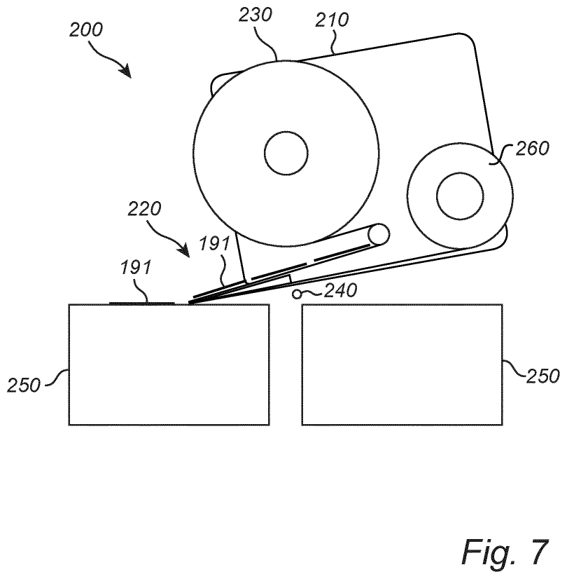

FIG. 7 illustrates, from one side, an exemplary applicator system 200 comprising a label dispenser 210 and a label applicator 220. Labels 19 are preprinted and provided on a roll 230. The label web supplied from the from the supply roll 230 passes the applicator on its way to the rewind roll 260 and labels are peeled off and applied onto items 250. A sensor 240 detects the items 250, e.g., arranged on a conveyor and provides the applicator controller (not shown) with signal to feed a label. The labels are provided to the applicator part as described previously.

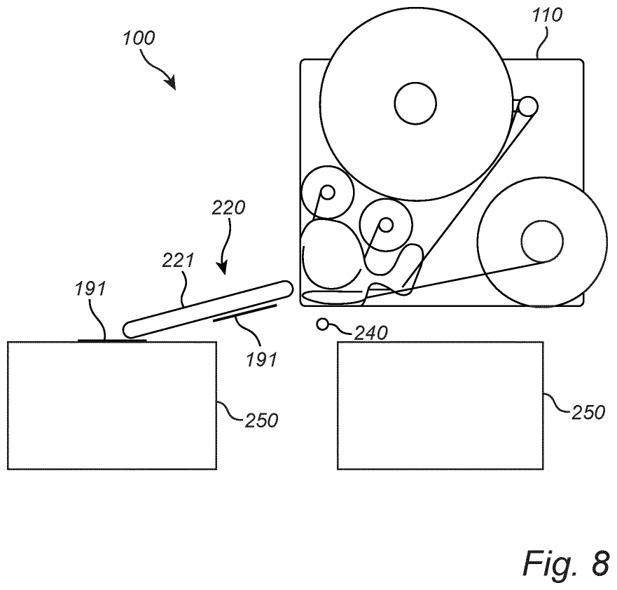

FIG. 8 illustrates, from one side, an exemplary print and apply system 100 comprising a label printer 110 and a label applicator 220. Labels 191 are printed by the printer as disclosed above and provided to the applicator 220. In this case labels are provided with non-adhesive on to the applicator conveyor 221. The labels are applied onto items 250 when they pass the one end of the applicator conveyor. A sensor 240 detects the items 250, e.g. arranged on a conveyor and provides the printer controller (not shown) with signal to print to trigger a label print and feed a label onto the applicator 220.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the disclosure may be implemented at least in part by means of both hardware and software, and that several “means”, “units” or “devices” may be represented by the same item of hardware.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

Software and web implementations of various embodiments of the disclosed methods can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A method executed by a controller of a label dispenser for dispensing labels from a label source (120, 230) to an edge portion of the label dispenser, the method comprising:
moving the labels between the label source and the label dispenser edge portion, and delivering the labels by moving the labels past the label dispenser edge portion of the label dispenser (position E) for application on one or more target objects,
wherein the method comprises:
controlling the movement of the labels in the label dispenser in at least two different speeds, wherein a first speed (V_{high}) is higher than a second speed (V_{low}), and
for each label, using a target time (T_{td}) which is between receiving a trigger signal and delivering said label to the label dispenser (position E), and
if the movement of the label is in a speed different than the first speed (V_{high}) accelerating the speed of the label to reach the delivery of the label (position E) in said first speed (V_{high}) substantially at the target time (T_{td}).

2. The method according to claim 1, the controller further determining based on the time available to target time (T_{td}) whether:
backfeed of the label is needed (state 1), in which case said label is (i) decelerated until its movement is stopped, and (ii) a backfeed operation is performed to bring said label in a correct position for a printing operation (position A), or no backfeed is needed (state 2), in which case printing of the label will continue at the first speed (V_{high}).

3. The method according to claim 2, the controller further timing the printing operation in state 2 in the time available to target time (T_{td}) and deciding either:
to print the label continuously at the first speed (V_{high}) until said label is moved completely past the label dispenser edge portion, or
to decelerate the label until it moves at the second speed (V_{low}) and to accelerate the label until it moves at the first speed (V_{high}) for delivery, potentially before accelerating maintaining the label at said second speed (V_{low}) for a determined amount of time to match the time available to target time (T_{td}).

4. The method according to one of the preceding claims, further moving the labels with constant acceleration and deceleration between the first speed (V_{high}) and the second speed (V_{low}).

5. The method according to one of the preceding claims, the controller further receiving information whether the subsequent label, or alternatively the labels will need to be printed.

6. The method according to one of the preceding claims, wherein the second speed (V_{low}) is not equal to 0 m/s when the label is printed.

7. The method according to one of the preceding claims, wherein the trigger signal is received from an external product detection sensor or an external control system.

8. The method according to any of claims 1 to 7, wherein successive trigger signals are associated with successive labels.

9. The method according to any of previous claims, obtaining information about a new label start, label length and a gap length between successive labels measured during a calibration process.

10. A label dispenser for dispensing labels to an edge portion of the label dispenser, said label dispenser comprising:
a label source (120),
an edge portion,
a label path extending between the label source and the edge portion, and
a controller configured to control the speed of the labels in the label path,
wherein the controller is configured to:
move the labels between the label source and the label dispenser edge portion, and delivering the labels by moving the labels past the label dispenser edge portion of the label dispenser (position E) for application on one or more target objects,
control the movement of the labels in the label dispenser in at least two different speeds, wherein a first speed (V_{high}) is higher than a second speed (V_{low}), and
for each label, use a target time (T_{td}) which is between receiving a trigger signal and delivering said label to the label dispenser (position E), and
determine if the movement of the label is in a speed different than the first speed (V_{high}) accelerating the speed of the label to reach the delivery of the label (position E) in said first speed (V_{high}) substantially at the target time (T_{td}).

11. The label dispenser according to claim 10, further comprising a printer arrangement (110).

12. The label dispenser according to claim 11, the controller is configured to determine if before finishing a print process of a first label a trigger signal for a second label is received, before printing the second label if time (T_{sb}) to start backfeed at delivering the second label to the label dispenser (position E) down to stand still occur, initiating a backfeed before printing the second label.

13. The label dispenser according to claim 12, initiating by the controller printing (section c) a third label substantially immediately after printing the second label while the second label is delivered.

14. The label dispenser according to claim 12, wherein the controller determines based on the time available to target time (T_{td}) whether:
backfeed of the label is needed (state 1), in which case said label is (i) decelerated until its movement is stopped, and (ii) a backfeed operation is performed to bring said label in a correct position for a printing operation (position A), or
no backfeed is needed (state 2), in which case printing of the label will continue at the first speed (V_{high}).

15. The label dispenser according to claim 12, wherein the controller further timing the printing operation in state 2 in the time available to target time (T_{td}) and deciding either:
to print the label continuously at the first speed (V_{high}) until said label is moved completely past the label dispenser edge portion, or
to decelerate the label until it moves at the second speed (V_{low}) and to accelerate the label until it moves at the first speed (V_{high}) for delivery, potentially before accelerating maintaining the label at said second speed (V_{low}) for a determined amount of time to match the time available to target time (T_{td}).

16. A computer program product, comprising instructions, which when executed on at least the processor (1032), cause the at least one processor to carry out the method according to any of claims 1-9.

17. A computer program product comprising a program code for performing, when executed by a processing circuitry, the method according to any of claims 1-9.

18. A non-transitory computer-readable storage medium comprises instructions, which when executed by a processing circuitry, cause the processing circuitry to perform the method according to any of claims 1-9.
